(19) United States
(12) Patent Application Publication
(10) Pub. No.: US 2005/0131685 A1
(43) Pub. Date: Jun. 16, 2005

(54) Installing language modules in a mobile communication device

(75) Inventors: Daniel L. Roth, Boston, MA (US); Jordan Cohen, Gloucester, MA (US); William Barton, Harvard, MA (US)

Correspondence Address: WILMER CUTLER PICKERING HALE AND DORR LLP, 60 STATE STREET, BOSTON, MA, 02109, US

(73) Assignee: Voice Signal Technologies, Inc., Woburn, MA (US)

(21) Appl. No.: 10/988,994

(22) Filed: Nov. 15, 2004

Related U.S. Application Data
(60) Provisional application No. 60/520,187, filed on Nov. 14, 2003.

(51) Int. Cl. G10L 15/00

(52) U.S. Cl. 704/231

(57) ABSTRACT

A method including: providing a mobile device (e.g. cellular phone) with a core engine for performing speech recognition; providing a plurality of sets of language-specific modules, each set of the plurality of sets for enabling the core engine to recognize a different language; selecting one set of language-specific modules among the plurality of sets of language-specific modules; and loading into memory within the mobile communication device the selected set of language-specific modules so as to enable the mobile communication device to recognize speech spoken in the language of the selected set.

This application claims the benefit of U.S. Provisional Application No. 60/520,187, filed Nov. 14, 2003.

### TECHNICAL FIELD

This invention relates to speech recognition in mobile communication devices.

### BACKGROUND OF THE INVENTION

Increasing numbers of different speech-enabled mobile phones are becoming commercially available. These phones enable the user to perform various functions through a speech recognition interface. The more sophisticated of these mobile phones support speaker-independent digit dialing, speaker-independent name dialing, and speaker-independent menu navigation on a mobile phone. Some of them also offer real time dictation of text messages.

Such speech-enabled mobile phones are being distributed throughout the world and are becoming available in more different languages including English, French, German, Japanese, Russian, Korean, and many others. The speech recognition program that is built for recognizing English will not work for recognizing French speech. So, typically different speech recognition programs need to be provided for the different languages that are supported. In that case, as the number of supported languages increases, so does the number of different versions of a particular a cell phone model (e.g. one for English, another for French, etc.).

### SUMMARY OF THE INVENTION

This invention relates generally to over-the-air, wired, or memory card provisioning of language in an embedded speech recognition system and/or application.

In general, in one aspect, the invention features a method including: providing a handheld mobile device (e.g. communication device) with a core engine for performing speech recognition; providing a plurality of sets of language-specific modules, each set of the plurality of sets for enabling the core engine to recognize a different language; selecting one set of language-specific modules among the plurality of sets of language-specific modules; and loading into memory within the mobile communication device the selected set of language-specific modules so as to enable the mobile communication device to recognize speech spoken in the language of the selected set.

In general, in another aspect, the invention features a method of enabling a handheld mobile device (e.g. communication device) that includes a core engine for performing speech recognition to perform speech recognition for a selected language. The method includes: connecting to a source of a set of language-specific modules which enable the core engine to recognize speech in the selected language; and from the source, loading the set of language-specific modules into memory within the mobile communication device so that the loaded set of language-specific modules may be externally referenced by the core engine to enable the core engine to perform speech recognition.

Other embodiments include one or more of the following features. The mobile communication device is a cellular phone. The language-specific modules are data structures. The plurality of sets of language-specific modules includes a corresponding different set for each of the following languages: English. French, German, Japanese. The set of language-specific modules includes one or more of the following: a language model module; an acoustic model module; a “unit” definitions module; a lexicon module; a grammar module; and a pronunciation guesser. The communication device includes a speech synthesizer which shares with the core engine some of the modules of the loaded set of language-specific modules. The communication device includes a speech synthesizer and the loaded set of language-specific modules includes a diphones module. The communication device includes a rendering engine and the loaded set of language-specific modules includes a fonts module.

In general, in still another aspect, the invention features a handheld mobile device (e.g. cellular phone) including: a core engine for performing speech recognition on an input signal that is derived from a received speech signal; and memory storing a set of language-specific modules enabling the core engine to perform speech recognition for a particular language, wherein language-specific modules of the set of language-specific modules are separate from the core engine and are externally referenced by the core engine.

Other embodiments include one or more of the following features. The wireless mobile communication device also includes an interface through which the set of language-specific modules are loaded into said memory from an external source. The wireless mobile communication device is a cellular phone. The language-specific modules are data structures. The language-specific modules include one or more of the following: a language model module; an acoustic model module; a “unit” definitions module; a lexicon module; a grammar module; and a pronunciation guesser.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a speech recognizer system in a cell phone.

FIG. 2 is a high-level block diagram of a smartphone.

### DETAILED DESCRIPTION

The described embodiment is a cell phone with an embedded speech recognition system that is segmented into a language-independent part (i.e., a core engine) and a separate, referenceable language-specific part made up of one or more modules (e.g. lexicon, acoustic models, language models, fonts, and other elements). In essence, the language part of the speech recognizer is represented by data structures that are separate from the core engine code and that can be externally referenced by the core engine. This architecture enables one to initially sell or distribute the phone with the core speech engine and either a null language setup (e.g. no language modules installed) or a default language setup (e.g. basic language support provided). Then later, at some point in the distribution chain, the language-specific modules for a particular language can be installed in the phone thereby provisioning it to support the language that is relevant to the end user.

Separating the language-specific and language-independent parts in this way enables the manufacturer to produce one version of the cell phone for all languages that are available on that platform rather than a separate version for each language. In other words, if fourteen different languages are supported, then instead of having to manufacture fourteen different versions of the phone, the manufacturer can provide one version of its phone that can be later provisioned for the appropriate one of the available languages. It also enables the user to change the language that is supported or to enhance the speech recognition capabilities that are available for the supported language by installing other appropriate language-specific modules.

This approach to designing the speech recognition functionality is particularly useful for cell phones and other handheld or mobile communication devices because of the limited amount of memory that is available in such devices, especially in the less expensive versions of those devices.

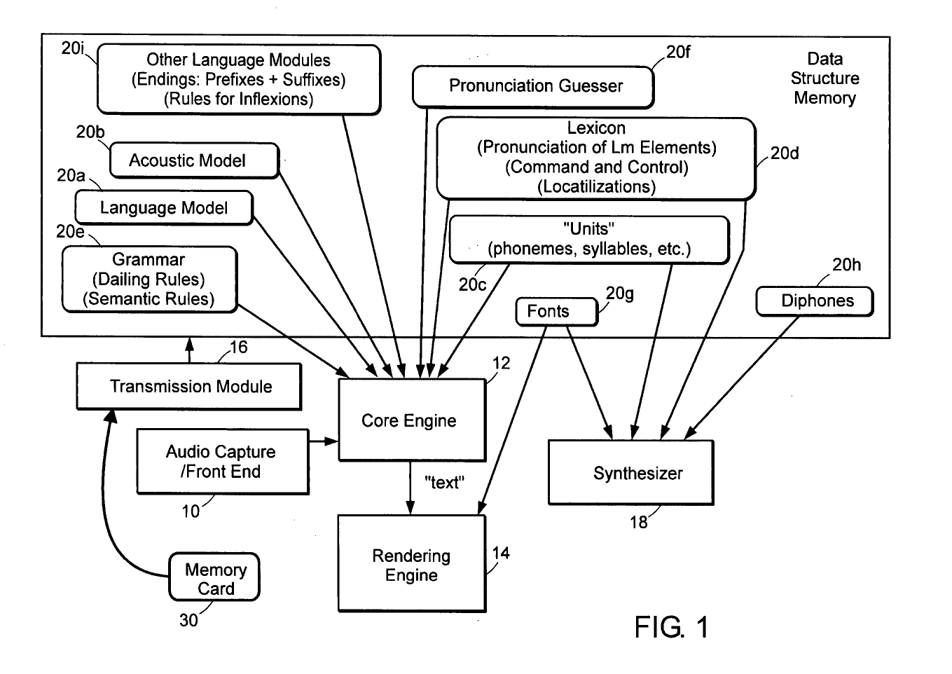

A block diagram of the software architecture of the cell phone is shown in FIG. 1. It includes an audio-capture/front-end module 10, a core engine 12, a rendering engine 14, a transmission module 16, a synthesizer 18, and a separate set of language-specific modules 20a-i stored in memory in the cell phone so that they can be externally referenced by core engine 12.

Audio-capture/front-end module 10 periodically samples the audio signal that is derived from the user's spoken input and it generates an acoustic representation of that sampled signal. Typically, the audio signal is sampled once every 10-30 msec. to generate a sequence of discrete signals. Then, signal processing techniques are applied to extract the properties of the sequence of discrete signal. This phase is often referred to as feature extraction. There are many different alternative representations that have been developed to represent the features of the speech signal including MFCC (Mel Frequency Cepstrum Coefficients) and LPC (Linear Prediction Coefficients).

Core engine 12 is essentially a search engine that searches a space of words and word sequences to find that word or word sequence that best matches the sequence of acoustic representations that were derived from the speech signal. Core engine 12 present its results as an ordered set of search results with the one having the highest probability listed first (i.e., the best result) followed by one or more alternatives with lower probabilities. In the described embodiment, the speech is modeled by a hidden Markov process and core engine 12 uses a Viterbi algorithm to find the best path through the hidden Markov process based on the received speech signal. It typically uses one or more of the various known techniques for performing that search in an efficient manner and for reducing the range of the search space that needs to be searched to find the best path.

Though the front-end is shown in FIG. 1 as being outside of and separate from core engine 12, it could instead be part of core engine 12.

Core engine 12 generates “text” which represents the recognized utterance or a list of recognized utterances. Rendering engine 14 puts this in an appropriate form for displaying to the user through a display device that is part of the cell phone.

Transmission module 16 provides an interface through which the language-specific modules can be installed in memory within the cell phone. It might include a card reader that reads the relevant data structures off of a memory card that is inserted into the phone. Or it might be a communication device for over-the-air transmission such as BREW, JAVA OTA provisioning (MIDP2.0, for instance), or for transmission over any other standard communications channel available to the portable device, or a communications channel supported by a wire, or supported by infrared or bluetooth, or any other digital communications medium.

In the described embodiment, language-specific modules 20a-i include modules for a language model 20a, an acoustic model 20b, “unit” definitions 20c, a lexicon 20d, a grammar 20e, a pronunciation guesser 20f, fonts 20g, and diphones 20h. These modules have been extracted from the speech recognition software and are embodied in data structures that are stored separately from the core engine code and that can be externally referenced by the core engine. By extracting them from the core engine in this way, it becomes possible to easily provision the cell phone with the modules that are appropriate for the language of the user. Techniques for assembling the information that is represented by these modules is well known and extensively described in the prior art. Thus, only brief descriptions of these modules are provided below and the reader is referred to the public technical literature for more complete discussions.

Language model module 20a presents a language model. It can be as simple as a list of words that can be recognized by the speech recognizer. More typically it provides a probabilistic or statistical model of how words go together to form sentences. It is probabilistic because for a particular sequence of words or phrases within the grammar, the model indicates the probability of speaking that sequence.

“Units” definitions module 20b defines the sub-units from which the words are constructed. These sub-units can be phonemes or syllables or any other set of elements that can be used to represent the words of the vocabulary. These are the units from which the lexicon is built.

Acoustic model module 20c defines what the elements sound like. That is, it presents acoustic representations of the elements or basic linguistic units (e.g. phonemes or combinations of phonemes) that are used to build word representations. In the described embodiment, the basic linguistic units are represented by hidden Markov models (HMMs).

Lexicon module 20d presents the pronunciations of the language model words. That is, it defines how the basic linguistic units are combined to generate the language model words. In the described embodiment, the words are represented by networks of phonemes. Each path through a network represents a pronunciation of that word.

Lexicon module 20d also contains the command and control words, i.e., the specific set of words that the user can use to control the interface. For example, one set of words might be used to control the interface in the English speaking countries. In a foreign language country, it is likely that the words that elicit those commands will not simply be translations of the English words but will instead be a different set of words. This information is contained in the lexicon module.

Grammar module 20e defines the set of rules associated with the language. For example, the rules define what combinations of words are grammatically permitted and what combinations are not. Grammar module 20e can also include a set of dialing rules, particularly if the purpose of the speech recognizer is to recognize telephone numbers. These rules define the constraints that are placed on a number string for it to be a valid phone number. For example the phone numbers used in one country might be different from the phone numbers used in another country. One country might use ten digits whereas the other country might use thirteen digits. In addition, valid phone numbers will not begin with a string of zeroes. And only certain three digit sequences are valid area exchanges. This type of information is reflected in the dialing rules.

Grammar module 20e can further include semantic rules. In the described embodiment, the semantic rules are limited to primarily identifying what to ignore in the recognized utterance when providing command and control functions. For example, in the phrase “Call Peter at home” the word “at” would typically be ignored since it carries no useful information.

Fonts module 20g provides information about the appropriate fonts to use in rendering the text on a display. For example, rendering in Russian needs to use the fonts that appropriate for Cyrillic and rendering in Greek needs to use fonts appropriate for that language. Fonts module 20g provides this information.

Other language modules 20i might present information regarding the beginnings and endings (i.e., prefixes and suffixes) of words. For some languages the lexicon is not sufficient and there needs to be information about how to generate plurals, etc. Also these other modules might include rules for inflexions which are important in some languages. For example, in Russian inflexions identify what part of speech the word is.

Pronunciation guesser module 20f provides rules for figuring out the pronunciation of words that are not found in the lexicon and it may also include alternative pronunciations for words that are in the lexicon.

Synthesizer 18 converts input text strings to synthesized speech that is output by the device. This might be used, for example, in generating prompts or confirmations of recognized speech. In the described embodiment, synthesizer 18 shares some of the data structures that are used by core engine 12 of the recognizer. For example, it shares lexicon module 20d, “units” definitions module 20c, and fonts module 20g. It also has its own language specific data structures which are not shared by core engine 12, e.g. a list of diphones 20h which indicate how to make the sounds for the various phonemes or combination of phonemes.

According to one scenario for taking advantage of the above design, the cell phone manufacturer build phones that are enabled for a default language, i.e., they include language-specific modules for the most commonly used language such as English. These phones are delivered to distributors for ultimate sale to end-users. The distributors or end-users of the cell phones then have the option of adding support for the language or languages used by the end user. The support for the language of the end-user can be installed within the phone either as an extension of the default language which came with the cell phone or as a replacement of the default language.

In the described embodiment, the language modules are supplied to the end-user on a memory card 30 that is inserted into the phone. These may be made available to the end-user at no extra cost as part of the original purchased package or they may be made available as an add-on or enhancement that is separately purchased by the end-user.

The cell phone includes a user interface that enables the user to load the language-specific modules from the card into the memory of the cell phone. In the embodiment described above, the user interface is implemented by transmission module 16. It employs a graphical user interface that is presented to the user via the cell phone's LCD and that enables the user to make the appropriate selections for provisioning the cell phone with the new language-specific modules. Upon selecting the desired language-specific modules, they are uploaded into the memory of the cell phone to supplement the modules with which the cell phone has already been provisioned or as replacements of those previously installed modules. If no language-specific modules had been previously installed, the uploaded language-specific modules are installed to initialize the system to the desired language.

This process may be performed by any entity along the distribute chain to the end-user. Also, as previously noted, other media may be used for loading the language-specific modules into the phone including, but not limited to, a USB connection to a PC, over-the-air transmission from the service provider using an available communication channel in the phone, and infra-red link from another device.

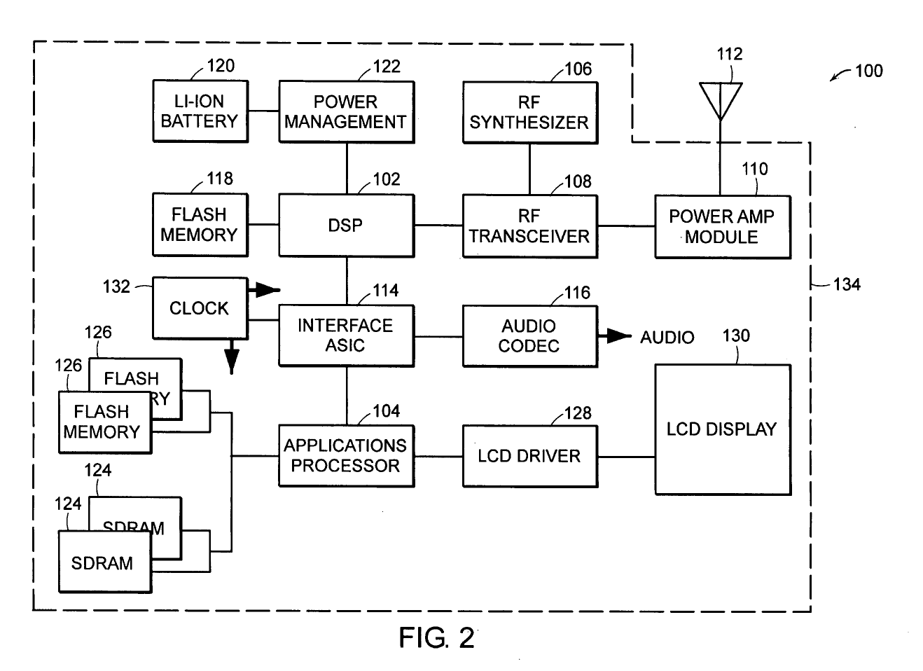

In the described embodiment, the functionality described above is implemented in a smartphone 100, such as is illustrated in the high-level block diagram form in FIG. 2. Smartphone 100 is a Microsoft PocketPC-powered phone which includes at its core a baseband DSP 102 (digital signal processor) for handling the cellular communication functions (including for example voiceband and channel coding functions) and an applications processor 104 (e.g. Intel StrongArm SA-1110) on which the PocketPC operating system runs. The phone supports GSM voice calls, SMS (Short Messaging Service) text messaging, wireless email, and desktop-like web browsing along with more traditional PDA features.

The transmit and receive functions are implemented by an RF synthesizer 106 and an RF radio transceiver 108 followed by a power amplifier module 110 that handles the final-stage RF transmit duties through an antenna 112. An interface ASIC 114 and an audio CODEC 116 provide interfaces to a speaker, a microphone, and other input/output devices provided in the phone such as a numeric or alphanumeric keypad (not shown) for entering commands and information. DSP 102 uses a flash memory 118 for code store. A Li-Ion (lithium-ion) battery 120 powers the phone and a power management module 122 coupled to DSP 102 manages power consumption within the phone. Volatile and non-volatile memory for applications processor 114 is provided in the form of SDRAM 124 and flash memory 126, respectively. This arrangement of memory is used to hold code for the operating system, code for customizable features such as a phone directory and the language-specific modules described above, and code for any applications software that might be in the smartphone, including the core engine of the speech recognizer mentioned above. The visual display device for the smartphone includes an LCD driver chip 128 that drives an LCD display 130. There is also a clock module 132 that provides the clock signals for the other devices within the phone and provides an indicator of real time.

All of the above-described components are packages within an appropriately designed housing 134.

In the described embodiment, the flash memory is available in two parts, namely, NOR flash and NAND flash. The NOR flash, which allows random access to any memory location, is used to store program and application code (such as for the core engine, the synthesizer, the rendering engine, etc.); while the NAND flash, which allows only sequential access to data, is used to store the data structures and language-specific modules.

Since the smartphone described above is representative of the general internal structure of a number of different commercially available smartphones and since the internal circuit design of those phones is generally well known to persons of ordinary skill in this art, further details about the components shown in FIG. 2 and their operation are not being provided and are not necessary to understanding the invention. For such details the reader is again referred to the publicly available technical literature.

Other embodiments are within the following claims. For example, the concepts described herein can also be implemented on any mobile, handheld device that includes an internal speech recognizer. The cellular phone is just one example of such a device. Another example that may not include the wireless communications component is a handheld computing device.

1. A method comprising:
providing a handheld mobile device with a core engine for performing speech recognition;
providing a plurality of sets of language-specific modules, each set of the plurality of sets for enabling the core engine to recognize a different language;
selecting one set of language-specific modules among the plurality of sets of language-specific modules; and
loading into memory within the mobile communication device the selected set of language-specific modules so as to enable the mobile communication device to recognize speech spoken in the language of the selected set.

2. The method of claim 1, wherein the mobile device is a handheld communication device.

3. The method of claim 1, wherein the mobile device is a cellular phone.

4. The method of claim 3, wherein the language-specific modules of each set of language-specific modules are data structures.

5. The method of claim 3, wherein the plurality of sets of language-specific modules includes a corresponding different set for each of the following languages: English. French, German, Japanese.

6. The method of claim 3, wherein the selected set of language-specific modules includes a language model module.

7. The method of claim 3, wherein the selected set of language-specific modules includes an acoustic model module.

8. The method of claim 3, wherein the selected set of language-specific modules includes a “unit” definitions module.

9. The method of claim 3, wherein the selected set of language-specific modules includes a lexicon module.

10. The method of claim 3, wherein the selected set of language-specific modules includes a grammar module.

11. The method of claim 3, wherein the selected set of language-specific modules includes a pronunciation guesser.

12. The method of claim 3, wherein the communication device includes a speech synthesizer which shares with the core engine some of the modules of the loaded selected set of language-specific modules.

13. The method of claim 3, wherein the communication device includes a speech synthesizer and the loaded selected set of language-specific modules includes a diphones module.

14. The method of claim 3, wherein the communication device includes a rendering engine and the loaded selected set of language-specific modules includes a fonts module.

15. A method of enabling a handheld mobile device that includes a core engine for performing speech recognition to perform speech recognition for a selected language, said method comprising:
connecting to a source of a set of language-specific modules which enable the core engine to recognize speech in the selected language; and
from the source, loading the set of language-specific modules into memory within the mobile communication device so that the loaded set of language-specific modules may be externally referenced by the core engine to enable the core engine to perform speech recognition.

16. The method of claim 15, wherein the handheld mobile device is a cellular phone.

17. The method of claim 16, wherein the set of language-specific modules includes a language model module.

18. The method of claim 16, wherein the set of language-specific modules includes an acoustic model module.

19. The method of claim 16, wherein the set of language-specific modules includes a “unit” definitions module.

20. The method of claim 16, wherein the set of language-specific modules includes a lexicon module.

21. The method of claim 16, wherein the set of language-specific modules includes a grammar module.

22. The method of claim 16, wherein the set of language-specific modules includes a pronunciation guesser.

23. A handheld mobile device comprising:
a core engine for performing speech recognition on an input signal that is derived from a received speech signal; and
memory storing a set of language-specific modules enabling the core engine to perform speech recognition for a particular language, wherein language-specific modules of the set of language-specific modules are separate from the core engine and are externally referenced by the core engine.

24. The handheld mobile device of claim 23, further including a transmitter/receiver for supporting wireless speech communications.

25. The handheld mobile device of claim 24, further comprising an interface through which the set of language-specific modules are loaded into said memory from an external source.

26. The handheld mobile device of claim 24, wherein the language-specific modules are data structures.

27. The handheld mobile device of claim 24, wherein the set of language-specific modules includes a language model module.

28. The handheld mobile device of claim 24, wherein the set of language-specific modules includes an acoustic model module.

29. The handheld mobile device of claim 24, wherein the set of language-specific modules includes a “unit” definitions module.

30. The handheld mobile device of claim 24, wherein the set of language-specific modules includes a lexicon module.

31. The handheld mobile device of claim 24, wherein the set of language-specific modules includes a grammar module.

32. The handheld mobile device of claim 24, wherein the set of language-specific modules includes a pronunciation guesser.
